(19) United States
(12) Patent Application Publication
(10) Pub. No.: US 2020/0211194 A1
(43) Pub. Date: Jul. 2, 2020

(54) ATTACHED OBJECT DETECTION APPARATUS

(71) Applicant: DENSO TEN Limited, Kobe-shi (JP)

(72) Inventors: Nobuhisa IKEDA, Kobe-shi (JP); Nobunori ASAYAMA, Kobe-shi (JP); Takashi KONO, Kobe-shi (JP); Yasushi TANI, Kobe-shi (JP); Daisuke YAMAMOTO, Kobe-shi (JP); Tomokazu OKI, Kobe-shi (JP); Teruhiko KAMIBAYASHI, Kobe-shi (JP)

(73) Assignee: DENSO TEN Limited, Kobe-shi (JP)

(21) Appl. No.: 16/581,889

(22) Filed: Sep. 25, 2019

(30) Foreign Application Priority Data
Dec. 28, 2018 (JP) 2018-246918

(51) Int. Cl. G06T 7/11; G06T 7/194; G06T 7/254; G06T 7/12; G06K 9/00

(52) U.S. Cl. CPC G06T 7/11; G06T 7/194; G06T 7/254; G06T 2207/10024; G06K 9/00805; G06T 2207/10016; G06T 7/12

(57) ABSTRACT

An attached object detection apparatus includes: an extractor that extracts, based on edges detected from pixels of a captured image captured by an image capturing apparatus, a candidate region for an attached object region corresponding to an attached object on the image capturing apparatus; and a determiner that determines, based on a fluctuation of luminance distribution of pixels within the candidate region extracted by the extractor, whether or not the candidate region is the attached object region.

### BACKGROUND OF THE INVENTION

### Field of the Invention

The invention relates to an attached object detection apparatus and an attached object detection method.

### Description of the Background Art

Conventionally, an attached object detection apparatus has been known that detects an object on a lens of a camera based on chronological change in luminance of a divided region generated by dividing a region of an image captured by the camera.

However, in the conventional technology, accuracy in attached object detection has yet to be improved. More specifically, an attached state of the attached object on the lens is not even, and attached state, such as a shape and luminance, varies, depending on the attached object. Thus, it cannot be said that all objects can be detected accurately.

### SUMMARY OF THE INVENTION

According to one aspect of the invention, an attached object detection apparatus includes: an extractor that extracts, based on edges detected from pixels of a captured image captured by an image capturing apparatus, a candidate region for an attached object region corresponding to an attached object on the image capturing apparatus; and a determiner that determines, based on a fluctuation of luminance distribution of pixels within the candidate region extracted by the extractor, whether or not the candidate region is the attached object region.

Thus, an attached object can be detected accurately.

Therefore, an object of the invention is to provide an attached object detection apparatus and an attached object detection method for detecting an attached object accurately.

These and other objects, features, aspects and advantages of the invention will become more apparent from the following detailed description of the invention when taken in conjunction with the accompanying drawings.

### BRIEF DESCRIPTION OF THE DRAWINGS

FIG. 1 illustrates an outline of an attached object detection method of this embodiment;

FIG. 2 is a block diagram showing a configuration of the attached object detection apparatus of this embodiment;

FIG. 3 illustrates a row of pixels to be extracted for luminance distribution;

FIG. 4 illustrates a process that is performed by a calculator;

FIG. 5 illustrates a process that is performed by the calculator;

FIG. 6 illustrates a process that is performed by the determiner;

FIG. 7 illustrates a process that is performed by the determiner;

FIG. 8 illustrates a process that is performed by the determiner;

FIG. 9 illustrates a process that is performed by the determiner;

FIG. 10 illustrates a process that is performed by the determiner; and

FIG. 11 is a flowchart that shows a procedure of an attached object detection process that is performed by the attached object detection apparatus of this embodiment.

### DESCRIPTION OF THE EMBODIMENTS

An attached object detection apparatus and an attached object detection method of the embodiment will be described with reference to the attached drawings. The present invention will not be limited by the embodiment described below.

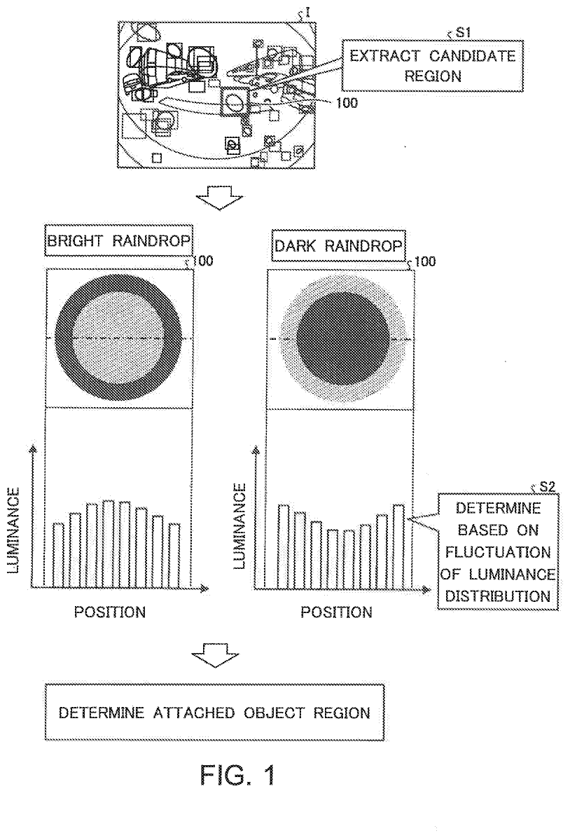

First, an outline of the attached object detection method of this embodiment will be described with reference to FIG. 1. FIG. 1 illustrates the outline of the attached object detection method of this embodiment. FIG. 1 shows a captured image I captured while a waterdrop, such as a raindrop, is on a lens of a vehicle-mounted camera.

When an attached object, such as mud, dust, a raindrop, and a snowflake, is on the lens of the camera, there is a possibility that information about surroundings of a vehicle such as a parking line, another vehicle, and a pedestrian cannot be obtained from the captured image I captured by the camera so that the parking line, the another vehicle, and the pedestrian may not be detected accurately. The attached object is not limited to mud, dust, a raindrop, and a snowflake, and may be an object that blurs a region having the object.

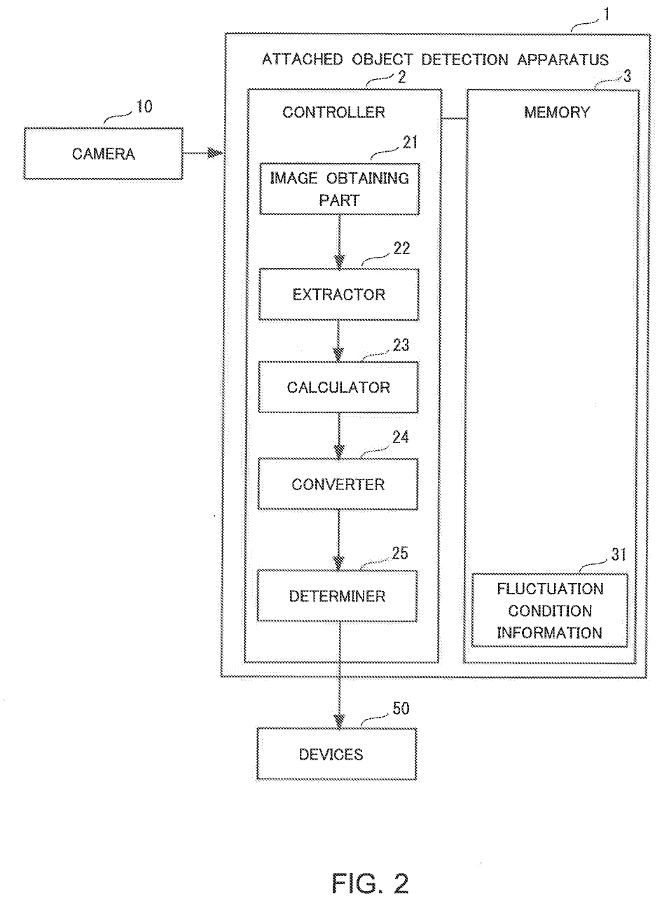

An attached object detection apparatus 1 of the embodiment (see FIG. 2) executes the attached object detection method so that detects the object on the lens of the camera based on the captured image I captured by the camera.

More specifically, the attached object detection method of this embodiment, first, extracts a candidate region 100 based on edges that are detected from pixels of the captured image I captured by the camera. A candidate region 100 is a candidate for an attached object region that corresponds to a region having an object on an image capturing apparatus (a step S1).

The attached object detection method of this embodiment extracts a rectangular region including a circular-shaped outline, such as an outline of a raindrop, as the candidate region 100, by a matching processing, such as a pattern matching.

Next, the attached object detection method of this embodiment determines whether or not the candidate region 100 is the attached object region based on an up and a down (fluctuation) of luminance distribution of pixels included in the extracted candidate region 100 (a step S2). The luminance distribution of the pixels means here a pattern of change in the luminance in a predetermined direction in a target image. For example, a predetermined coordinate (x0, y0) in the image is set as an origin. In a case in which luminance of a pixel in a horizontal direction x is L (x), a plotted pattern of the graph x-L (x) is referred to as the luminance distribution of the pixels, in the horizontal direction having the origin (x0, y0). The x0 and the y0 can be freely set, and a direction and an angle can be also set freely, including a vertical direction.

In FIG. 1, middle drawings illustrate: luminance distribution of a “bright raindrop,” having luminance of a center region of the attached object region higher than luminance of an outer region of the attached object region, and luminance distribution of a “dark raindrop,” having luminance of the center region of the attached object region lower than luminance of the outer region of the attached object region. In other words, when an object is on the lens, the attached object region is roughly categorized into two types of i) a blurred attached object region having the center region brighter than the outer region (bright raindrop) and ii) a blurred attached object region having the center region darker than the outer region (dark raindrop).

The graphs showing the luminance distribution in FIG. 1 shows the luminance distribution of pixels in a row lining in the horizontal direction in the candidate region 100. In the graph, luminance data of a bar corresponding to each “position” in a horizontal axis is a representative luminance value of a unit region that is generated by dividing a pixel line by a predetermined number of pixels. The unit region, calculation of the representative luminance value, etc. will be described later.

For example, in a case of the “bright raindrop,” luminance of a center region of the candidate region 100 is higher than luminance of an outer region of the candidate region 100. Thus, a shape of the fluctuation of the luminance distribution is convexity. In a case of the “dark raindrop,” the luminance of the center region of the candidate region 100 is lover than the luminance of the outer region. Thus, a shape of the fluctuation of the luminance distribution is a concavity. Each of the two types of raindrops, the “bright raindrop” and the “dark raindrop,” generally has a typical fluctuation of the luminance distribution, regardless of an attached state of the attached object or characteristics of a camera.

Thus, in the attached object detection method of this embodiment, in a case where the luminance distribution of the candidate region 100 has a similar fluctuation pattern to a predetermined fluctuation pattern of the luminance distribution of the attached object, the candidate region 100 is determined as the attached object region.

Even if a shape or another attached state of the attached object is different from a model or even if a characteristic of the captured image I is changed due to change of the cameras, the fluctuation patterns are consistent in the luminance distribution. Thus, the attached object can be detected accurately. In other words, the attached objects can be detected accurately by the attached object detection method of the embodiment.

By use of the attached object detection method of this embodiment, the attached object region is determined based on an amount of change in fluctuation of the luminance distribution. This will be described later. The change in the fluctuation is defined here as a pattern showing a change amount of luminance of the pixels lined in a predetermined direction in the target image. The change amount of the luminance is, more specifically, a derivative value, a difference value, etc.

Further, by use of the attached object detection method of this embodiment, in a case where a raindrop or another attached object reflects light so that the fluctuation of the luminance distribution is in an imperfect convex shape or in an imperfect concavity shape, it is possible to detect the attached object region by setting a separate condition that defines the fluctuation. This will be described later.

With reference the FIG. 2, a configuration of the attached object detection apparatus 1 of this embodiment will be described next. FIG. 2 is a block diagram showing the configuration of the attached object detection apparatus 1. As shown in FIG. 2, the attached object detection apparatus 1 of this embodiment is connected to a camera 10 and a variety of devices 50. FIG. 2 illustrates the configuration of the attached object detection apparatus 1 as a separate unit from the camera 10 and the devices 50. However, the configuration of the attached object detection apparatus 1 is not limited to this. The attached object detection apparatus 1 may be configured to be as one unit with the on-vehicle camera 10 or one of the devices 50.

The camera 10 is an on-vehicle camera that includes, for example, a lens, such as a fisheye lens, and an image capturing sensor, such as a charge coupled device (CCD) and a complementary metal oxide semiconductor (CMOS). The camera 10 is installed in each of positions, for example, to capture images showing front, rear and side areas of the vehicle. The camera 10 outputs the captured image I to the attached object detection apparatus 1.

The devices 50 obtain a detection result detected by the attached object detection apparatus 1 to perform various controls for the vehicle. The devices 50, for example, include a display apparatus that gives information to a user about the attached object on the lens of the camera 10 and gives a message to the user that the attached object needs to be removed. Other examples of the devices 50 are a removal apparatus that removes the attached object from the lens by ejecting fluid, air, or the like toward the lens, and a vehicle control apparatus that controls autonomous driving of the vehicle, etc.

As shown in FIG. 2, the attached object detection apparatus 1 of this embodiment includes a controller 2 and a memory 3. The controller 2 includes an image obtaining part 21, an extractor 22, a calculator 23, a converter 24, and a determiner 25. The memory 3 stores fluctuation condition information 31.

The attached object detection apparatus 1 includes, for example, a computer and other circuits. The computer includes a central processing unit (CPU), a read only memory (ROM), a random access memory (RAM), a data flash, an in/out port, etc.

The CPU of the computer functions as the image obtaining part 21, the extractor 22, the calculator 23, the converter 24, and the determiner 25 of the controller 2, for example, by reading out and executing a program stored in the ROM.

Moreover, at least one or all of the image obtaining part 21, the extractor 22, the calculator 23, the converter 24, and the determiner 25 of the controller 2 may be configured by hardware, such as an application specific integrated circuit (ASIC) and field programmable gate array (FPGA).

The memory 3 is, for example, a RAM or a data flash memory. The RAM or the data flash memory stores the fluctuation condition information 31, information of programs, etc. The attached object detections apparatus 1 may obtain the foregoing programs and information from a portable memory or from another computer connected to the attached object detection apparatus 1 via a wireless or wired network.

The fluctuation condition information 31 stored in the memory 3 is information including a condition that is used for a determination process, described later, performed by the determiner 25. An example of the condition is a pattern condition for the fluctuation of the luminance distribution. The pattern condition includes a fluctuation patterns when the luminance distribution is mapped, a pattern of luminance data of pixels in a row/column of the luminance distribution, etc. The determination process that uses the fluctuation condition information 31 will be described later.

The controller 2 i) extracts, based on the edges from the pixels of the captured image I captured by the camera 10, the candidate region 100 for the attached object region, and ii) determines, based on the fluctuation of the luminance distribution of the extracted candidate region 100, whether or not the candidate region 100 is the attached object region.

The image obtaining part 21 obtains the image captured by the camera 10 to generate (obtain) the current captured image I that is a current frame. More specifically, the image obtaining part 21 performs grayscale processing that converts pixels of the obtained captured image into gray level from white to black based on luminance of the pixels of the captured image.

The image obtaining part 21 performs a thinning process of the pixels in the obtained captured image to generate an image having a reduced size as compared to the obtained captured image. The image obtaining part 21 generates an integral image from values of the pixels and an integral image from square values of the pixels, based on the thinned captured image. The values of the pixels are information about luminance and edges of the pixels.

As a result, since the attached object detection apparatus 1 performs the thinning process of the obtained captured images, and generates the integral images, the attached object detection apparatus 1 speeds up calculation in a later process so that the attached object can be detected in a shorter processing time period.

The image obtaining part 21 may perform a smoothing process of the pixels, using a smoothing filter, such as an averaging filter. Further, the image obtaining part 21 may generate the current frame having a same size as a size of the obtained captured image, without performing the thinning process.

The extractor 22 extracts the candidate region 100 for the attached object region from the captured image I obtained by the image obtaining part 21. More specifically, the extractor 22 first extracts luminance and edge information of each of the pixels in the captured image I. The luminance of each pixel is expressed by, for example, a parameter from 0 to 255.

The extractor 22 performs an edge detection process based on the luminance of each pixel to detect the edges in the X-axis direction (a left-right direction of the captured image I) and a Y-axis direction (an up-down direction of the captured image I) of the pixel. Any edge filter, for example, a sobel filter or prewitt filter, may be used for the edge detection process.

The extractor 22 detects, as the edge information, a vector that includes information of an edge angle and an edge strength of the pixel, using trigonometric function based on the edge in the X-axis direction and the edge in the Y-axis direction. More specifically, the edge angle is expressed by a direction of the vector, and the edge strength is expressed by a length of the vector.

The extractor 22 performs a matching process (template matching) that matches the detected edge information with preliminarily prepared template information showing an outline of an attached object to extract edge information similar to the template information. Then, the extractor 22 extracts a region corresponding to the extracted edge information, i.e., extracts the rectangular candidate region 100 including the outline of the attached object.

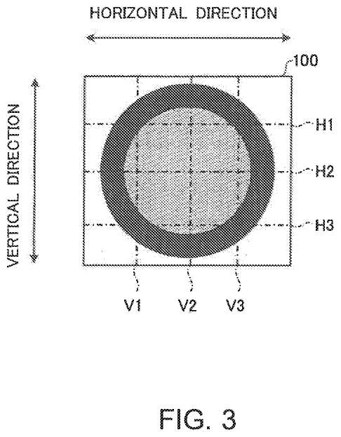

Next, the extractor 22 extracts luminance distribution of pixels in a predetermined row in the extracted candidate region 100. FIG. 3 illustrates the row of the pixels to be extracted for the luminance distribution. As shown in FIG. 3, the extractor 22 extracts the luminance distribution of three pixel rows H1 to H3 in the horizontal direction and three pixel columns V1 to V3 in the vertical direction in the captured image I. Thus, the luminance distribution can be treated as a two dimensional information so that processing load in the later process can be reduced.

The extractor 22 may extract rows/columns of pixels in one of the horizontal direction and the vertical direction. Number of the extracted rows and columns are three each in this embodiment. However, the number is not limited to three, and the number may be two or less or four or more.

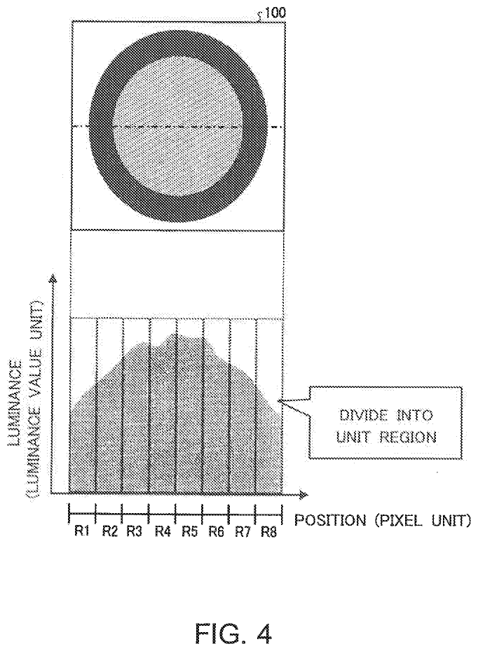

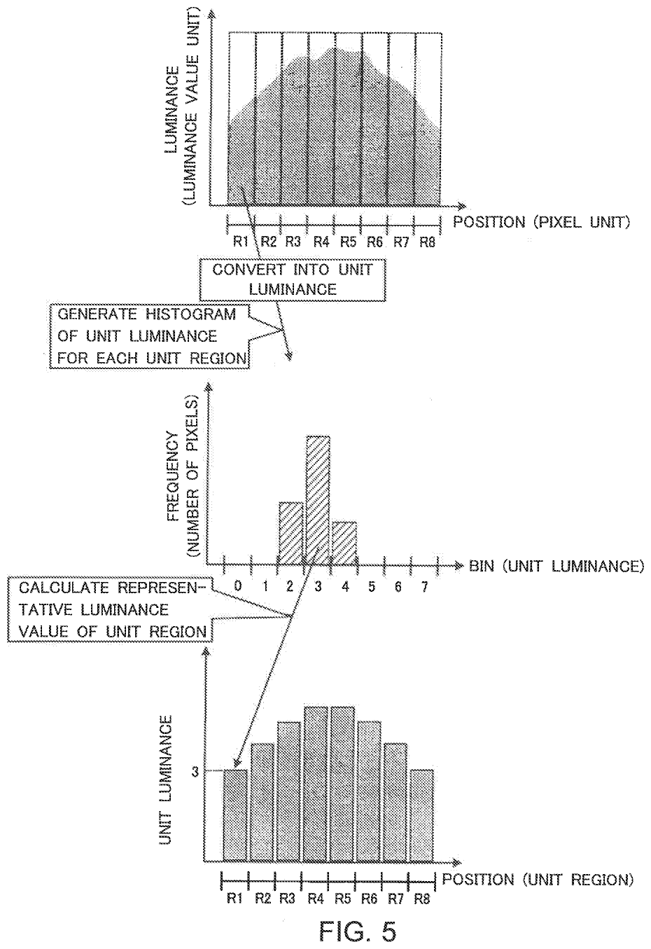

With reference back to FIG. 2, the calculator 23 will be described. The calculator 23 divides the candidate region 100 extracted by the extractor 22 into unit regions, i.e., predetermined number of pixels is set as a unit, and the candidate region 100 is divided by the unit into the unit regions. Then, the calculator 23 calculates a representative luminance value for each unit region. A calculation method of the representative luminance value that is used by the calculator 23 will be described later with reference to FIGS. 4 and 5.

A predetermined range of luminance is set as a unit, and the converter 24 converts luminance of pixels in the candidate region 100 into unit luminance. For example, the converter 24 converts the parameter (values) indicative of luminance from 0 (zero) to 255, into the unit luminance by dividing the parameter of luminance by the predetermined range as a unit. The representative luminance value that is calculated by the calculator 23, described above, can be expressed by the unit luminance that is converted by the converter 24 from luminance. This will be described with reference to FIGS. 4 and 5.

FIGS. 4 and 5 illustrate a process that is performed by the calculator 23. First, with reference to FIG. 4, a method for setting the unit region that is set by the calculator 23. FIG. 4 illustrates luminance distribution of a pixel row H lining in the horizontal direction.

As shown in FIG. 4, the calculator 23 divides the horizontal pixel row H into, for example, eight unit regions R1 to R8 (hereinafter also referred to collectively as “unit region R”). Widths (number of pixels) of the unit regions R1 to R8 may be same (i.e., equally divided) or may be different from one another.

Number of the divided unit regions R is not limited to eight, and the number may be set freely. It is recommended that the number of the divided unit regions R (eight in FIG. 4) should be unchanged regardless of size of the candidate region 100 that is extracted from the captured image I. Thus, since the number of the unit regions R is unchanged even if the sizes of the extracted candidate regions 100 are varied, derived information is consistent so that the processing load in the later process, e.g., a determination process, will be reduced.

Next, as shown in. FIG. 5, the calculator 23 calculates the representative luminance value for each unit region R. As shown in an upper drawing of FIG. 5, the converter 24 converts luminance (e.g., 0 to 255) of each pixel into the unit luminance prior to the calculation of the representative luminance value by the calculator 23. More specifically, in FIG. 5, the luminance parameter from 0 to 255 is equally divided into eight to be converted into the unit luminance, shown as “0” to “7” in a middle drawing in FIG. 5. In this case, a luminance value range for each is 32 in the unit luminance. For example, “0 (zero)” in the unit luminance corresponds to luminance values from 0 to 31, and “1” in the unit luminance corresponds to luminance values from 32 to 63. In other words, the conversion into the unit luminance is a processing of reducing number of divisions of the luminance parameter. Since the number of the divisions of the luminance parameter in the luminance distribution can be reduced to desired number of divisions as the unit luminance, the processing load in the later process can be reduced. In the conversion from luminance to the unit luminance, the number of the divisions and the range for each division are freely settable. The unit luminance is equally divided in the foregoing description, but may not be equally divided.

Then, the calculator 23 generates a histogram of the unit luminance for each of the unit regions R1 to R8. The middle drawing in FIG. 5 shows the histogram of the unit region R1, having bin representing the unit luminance 0 to 7, and frequency representing number of pixels.

Next, as shown in a lower drawing in FIG. 5, the calculator 23 calculates the representative luminance value for each of the unit regions R1 to R8, based on the generated histograms. For example, the calculator 23 finds a bin having a most frequent value (bin “3” in FIG. 5) of the unit luminance in the histogram, and calculates the value of the unit luminance as the representative luminance value of the unit region R1. Since number of the luminance distribution data is reduced from number of pixels to number of the unit regions R, the processing load in the later step can be reduced.

The calculator 23 determines the unit luminance of the most frequent value as the representative value. However, a representative value is not limited to this. For example, the calculator 23 may determine a median value, an average value or the like in the histogram as the representative value.

Calculation of the representative luminance value is not limited to the calculation of the representative luminance value based on the histogram. For example, the calculator 23 may calculate an average luminance value for each of the unit regions R, and may find and determine a value of the unit luminance corresponding to the calculated average luminance value as the representative value.

The calculator 23 determines the representative value in the unit luminance. However, the calculator 23 may use an average luminance value of the unit regions R, etc. as the representative value. In other words, the representative value may be expressed by the unit luminance or the luminance value.

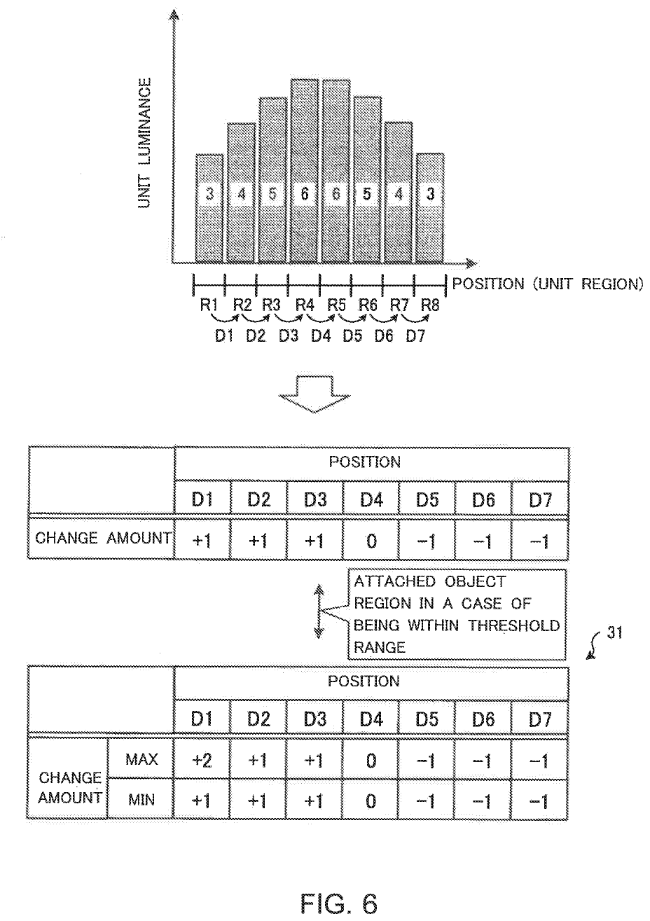

With reference hack to FIG. 2, the determiner 25 will be described. The determiner 25 determines, based on the fluctuation of the luminance distribution of the pixels in the candidate region 100, whether or not the candidate region 100 is the attached object region. With reference to FIGS. 6 to 10, determination processes that are performed by the determiner 25 will be described here.

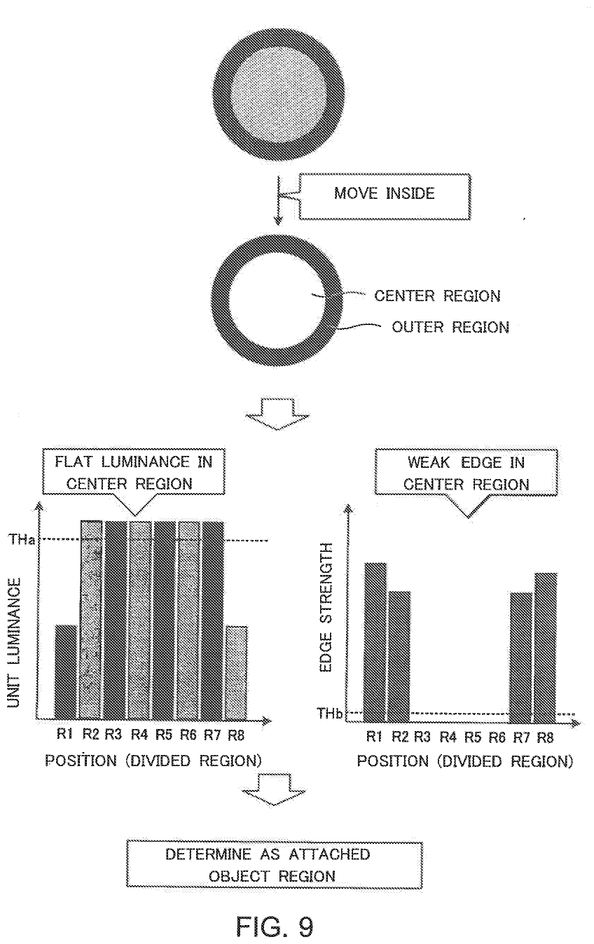

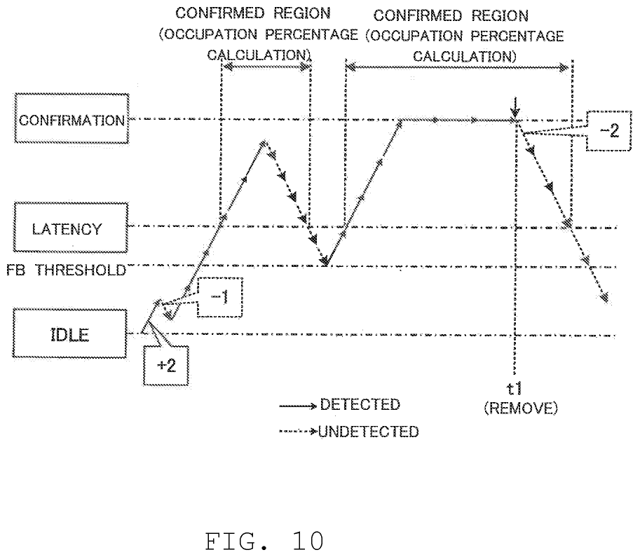

FIGS. 6 to 10 illustrate the processes that are performed by the determiner 25. FIGS. 6 to 8 illustrate a determination process for determining a blurred attached object region in the captured image I. FIG. 9 illustrates a determination process for determining a very bright attached object region having high luminance due to reflection of light on a waterdrop, such as a raindrop. FIG. 10 illustrates a determination process for determining continuity of the attached object region.

With reference to FIGS. 6 to 8, the determination process for determining the blurred attached object region will be described. The blurred attached object region is here defined as regions having the “bright raindrop” and the “dark raindrop” in FIG. 1. An upper drawing in FIG. 6 illustrates the luminance distribution of the candidate region 100. The representative values of the unit regions R1 to R8 are shown in bars.

As shown in the upper drawing in FIG. 6, the determiner 25 calculates change amounts D1 to D7 of the unit luminance between two adjacent unit regions amongst the unit regions R1 to R8. More specifically, the determiner 25 calculates differences between the two adjacent unit regions as change amounts. In other words, the determiner 25 calculates a change in luminance between two adjacent unit regions as the change amount. The change amount is here simply the differences of the unit luminance between the two adjacent unit regions. However, a calculating method for the change amounts is not limited to this. For example, the determiner 25 may generate a continuous function indicating the luminance distribution by use of a complementary method, and may calculate a derivative value of the continuous functions as the change amount. An upper table of a lower drawing in FIG. 6 is a table having the change amounts D1 to D7.

In a case where a fluctuation pattern of the luminance distribution satisfies a predetermined pattern of change, the determiner 25 determines that the candidate region 100 is the attached object region. More specifically, the determiner 25 compares each of the change amounts D1 to D7 with the fluctuation condition information 31 stored in the memory 3 to perform the determination process.

A lower table of the lower drawing in FIG. 6 is an example of a table including threshold ranges for the change amounts D1 to D7, as an example of the fluctuation condition information 31. In a case where the change amounts D1 to D7 of the candidate region 100 are within the threshold ranges of the change amounts D1 to D7 in the fluctuation condition information 31, the determiner 25 determines that the candidate region 100 is the attached object region.

In other words, in a case where the pattern of the change amounts D1 to D7 of the unit luminance of the unit regions R1 to R8 satisfies the threshold ranges set in the fluctuation condition information 31, the determiner 25 determines that the region is the attached object region.

In other words, the determiner 25 stores, as the threshold ranges in the fluctuation condition information 31, characteristics of the “bright raindrop” that luminance gradually gets higher toward a center region of the candidate region 100, and performs the determination process based on the stored threshold ranges. As for the “dark raindrop,” the determiner 25 stores, as the threshold ranges in the fluctuation condition information 31, characteristics of the “dark raindrop” that luminance gradually gets lower toward the center region of the candidate region 100, and performs the determination process based on the stored threshold ranges. Thus, the determiner 25 detects the blurred regions, such as the “bright raindrop” and the “dark raindrop,” as the attached object region.

Moreover, the determiner 25 uses the change amounts D1 to D7 so as to disregard whether values in luminance of the unit regions R are high or low as a whole. Thus, the attached object detection apparatus 1 reduces a possibility of a determination error that is caused when the fluctuation pattern is similar, and the values in luminance are high or low. Further, since the determiner 25 disregards whether the luminance is high and low i) there is no need to set a determination condition for ach luminance, ii) a storage space for storing the condition is saved, and ii) the processing load can be reduced because there is no need to perform the determination process for each luminance.

Further, in order to give flexibility; a maximum change amount and a minimum change amount may be set for the change amounts D1 to D7 in the fluctuation condition information 31. In that case, the attached object detection apparatus 1 detects the attached object region if the attached object region has a distorted shape. In other words, the attached object detection apparatus 1 accurately detects the attached object region even if attached objects have different shapes.

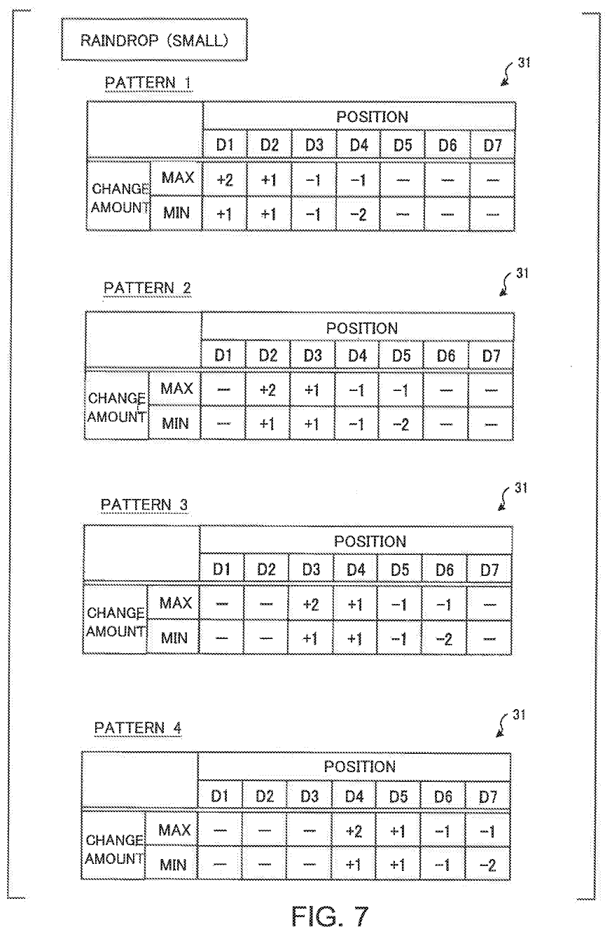

FIG. 6 shows a case in which the threshold ranges are set for all the change amounts D1 to D7 in the fluctuation condition information 31. However, for example, as shown in FIG. 7, in a case where the attached object region of a small sized attached object is detected, threshold ranges only for a portion of the change amounts D1 to D7 may be set.

FIG. 7 shows four patterns of the fluctuation condition information 31 for detecting a raindrop smaller than a predetermined size amongst raindrops that are attached objects.

More specifically, a pattern 1 in FIG. 7 shows threshold ranges for the change amounts D1 to D4; a pattern 2 in FIG. 7 shows threshold ranges for the change amounts D2 to D5; a pattern 3 in FIG. 7 shows threshold ranges for the change amounts D3 to D6; and a pattern 4 in FIG. 7 shows threshold ranges for the change amounts D4 to D7;

In other words, as shown in the pattern 1 to the pattern 4, the fluctuation condition information 31 includes the threshold ranges for the portion of the change amounts. In a case where the portion of the change amounts D1 to D7 in the candidate region 100 satisfies one of the patterns 1 to 4, the determiner 25 determines that the candidate region 100 is the attached object region.

Thus, even in the case where a region of a small sized attached object exists in the candidate region 100, undetected regions can be reduced. In other words, the attached object region can be accurately detected.

Further, as shown in the patterns 1 to 4, in a case where a same threshold range is set for different change amounts, even when a position of the attached object region changes within the candidate region 100, the attached object region can be accurately detected.

FIG. 7 shows the case where the threshold ranges are set for the four serial change amounts among the seven change amounts D1 to D7. However, number of the change amounts is not limited to four. The number of the change amounts may be three or smaller, or five or greater.

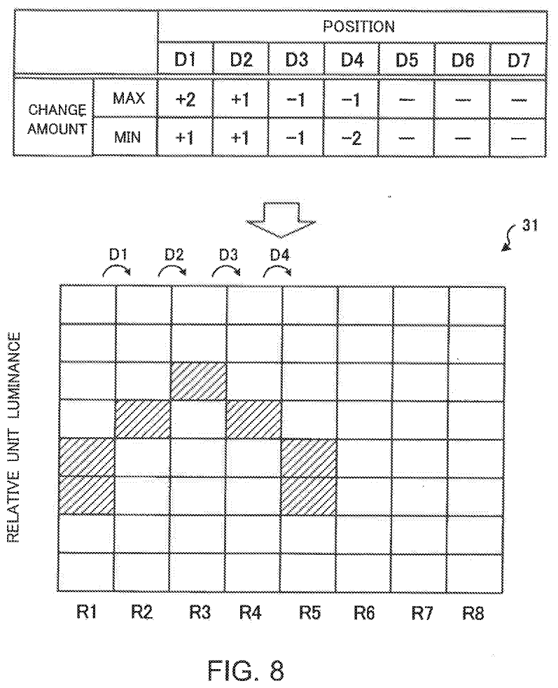

Moreover, FIGS. 6 and 7 show the case in which the determiner 25 determines the attached object region based on whether or not the change amount is included in the threshold range in the fluctuation condition information 31. However, for example, the determiner 25 may determine the attached object region based on the fluctuation condition information 31 having a mapped fluctuation of the luminance distribution. The fluctuation of the luminance distribution has been mapped based on the threshold ranges for the change amounts D1 to D7. This is will be described with reference to FIG. 8.

An upper drawing in FIG. 8 illustrates the threshold ranges for the change amounts of the fluctuation of the luminance distribution. A lower drawing in FIG. 8 illustrates the fluctuation condition information 31 having the mapped threshold ranges for the change amounts D1 to D4 shown in the upper drawing in FIG. 8. More specifically, the lower drawing in FIG. 8 is the map having a horizontal axis represents position of the unit regions R1 to R8, and a vertical axis represents relative luminance. The map is preliminarily generated.

For example, since the change amount D1 has a threshold range from +1 to +2, two blocks in predetermined positions of the relative luminance are set as a threshold for the unit region R1. One block is set for the unit region R2 in a predetermined position that satisfies the threshold range for the change amount D1. Next, since the change amount D2 has a value +1, a threshold is set at a block of the unit region R3 that is one block higher than the block set for the unit region R2. Next, since the change amount D3 has a value −1, a threshold is set at a block of the unit region R4 that is one block lower than the block set for the unit region R3. Next, since the change amount D4 has a threshold range from −2 to −1, a threshold is set in two blocks of the unit region R5 that is one and two blocks lower than the block set for the unit region R4. Thus, the map of the fluctuation condition information 31 is completed.

In other words, the map in the fluctuation condition information 31 is information indicating the fluctuation pattern of the unit luminance in the unit regions R1 to R5, based on the change amounts D1 to D4. As for the unit regions R6 to R8, since the threshold ranges are not set for the change amounts D5 to D7, there is no problem with any luminance detected in the unit regions R6 to R8.

The determiner 25 generates the map based on the change amounts D1 to D7 for the unit regions R1 to R8 in the extracted candidate region 100 by a similar method to the foregoing method. Then, the determiner 25 performs a matching process for checking whether the generated map matches the map in the fluctuation condition information 31. In a case where those maps match each other, the determiner 25 determines that the candidate region 100 is the attached object region.

In the example shown in FIG. 8, in a case where the map of the candidate region 100 is in a convexity shape as shown in the map in the fluctuation condition information 31, the determiner 25 determines that the candidate region 100 is the attached object region of the “blight raindrop.” In a case where the map of the candidate region 100 is in a concave shape as shown in the map in the fluctuation condition information 31, the determiner 25 determines that the candidate region 100 is the attached object region of the “dark raindrop.”

In other words, in the case where the fluctuation of the luminance distribution of the candidate region 100 is in the convexity shape or in the concave shape, the determiner 25 determines that the candidate region 100 is the attached object region. Thus, this determination process is performed for determining the attached object region only by using the fluctuation pattern excluding an element of luminance (unit luminance). Thus, it is possible to reduce undetected attached object region due to high and low luminance. Therefore, the attached object can be accurately detected.

Next, with reference to FIG. 9, a determination process for a case in which the attached object reflects light will be described. As shown in an upper drawing in FIG. 9, for example, when the vehicle has moved inside from an outside, a waterdrop, such as a raindrop, that is the attached object, is in the captured image, reflecting light installed inside. Thus, luminance in the center region of the attached object region is extremely high as compared to the outer region of the attached object region.

Therefore, the determiner 25 separately sets, as the fluctuation condition information 31, a condition using the feature that the center region of the attached object region has higher luminance, and performs a determination process. More specifically, the determiner 25 performs the determination process, using the unit luminance and information of edge strength for each of the unit regions R1 to R8. The edge strengths of the unit regions R1 to R8 are averages of edge strengths of pixels included in the unit regions R1 to R8.

In a case where i) luminance of each pixel within the center region of the candidate region 100 is equal to or greater than a predetermined threshold, and also ii) the edge strength of each pixel within the center region of the candidate region 100 is less than a predetermined value, the determiner 25 determines that the candidate region 100 is the attached object region.

More specifically, as shown in FIG. 9, in the case where i) the unit luminance of the unit regions R3 to R7 in the center region (a region corresponding to the center region of the attached object region, and in this case, the unit regions R3 to R7) of the candidate region 100 are equal to or greater than a threshold THa, and also ii) the edge strengths of the unit regions R3 to R7 are smaller than a predetermined threshold THb, the determiner 25 determines that the candidate region 100 is the attached object region.

In other words, since the luminance of the center region of the attached object region is high in a case of the attached object reflecting light, the determination process is performed by use of facts that a fluctuation of the luminance distribution in the center region is flat and that the edge strength in the center region is weak. Thus, the attached object reflecting light can be accurately detected by performing the determination process by use of a condition set based on characteristics of an image having the attached object reflecting light.

For example, in a case where a change amount between the center region and the outer region of the candidate region 100 is equal to or greater than a predetermined threshold in the luminance distribution of the unit regions R1 to R8, the determiner 25 may determine that the candidate region 100 is the attached object region having the attached object reflecting light.

Next, in a case where the determiner 25 continuously determines that the candidate region 100 is the attached object region based on a plurality of the captured images I captured time sequentially, the determiner 25 determines that the candidate region 100 is a confirmed attached object region.

Next, with reference to FIG. 10, the determination process, performed by the determiner 25, for determining a continuity of the attached object region will be described. FIG. 10 is a state machine diagram indicating shift in state of an attached object on the candidate region 100. In FIG. 10, one arrow indicates one determination process (i.e., one frame of the captured image I) performed by the determiner 25. A solid line arrow indicates that the determiner 25 has determined that the candidate region 100 is the attached object region in the determination process. A broken line arrow indicates that the determiner 25 has determined that the candidate region 100 is not the attached object region in the determination process.

As shown in FIG. 10, the candidate region 100 can shift to three states: “IDLE,” “latency,” and “confirmation.” The state “IDLE” indicates an “undetected state,” i,e., a state in which no attached object is on the candidate region 100. The state “latency” indicates a state in which there is a possibility that an attached object may be on the candidate region 100. The state “confirmation” indicates a state in which an attached object is on the candidate region 100.

Every time in which the determiner 25 performs the determination process for determining whether or not the candidate region 100 is the attached object region, the determiner 25 gives to each candidate region 100 a score according to a determination result. In a case where the candidate region 100 of which a sum of the scores satisfies a predetermined threshold condition, the determiner 25 determines that the candidate region 100 is the confirmed attached object region.

More specifically, the determiner 25 adds or subtracts a figure to/from the score according to the determination result. When the sum of the scores is equal to or greater than a threshold for the “latency,” the determiner 25 determines that the candidate region 100 is the confirmed attached object region, and uses the confirmed attached object region for an occupation percentage calculation, described later.

More specifically, as shown in FIG. 10, in the case where the determiner 25 determines that the candidate region 100 is the attached object region, the determiner 25 adds 2 (two) to the sum of the scores. On the other hand, in a case where the determiner 25 determines that the candidate region 100 is not the attached object region, the determiner 25 subtracts 1 (one) or 2 (two) from the sum of the scores. Before the state becomes the state “confirmation,” the determiner 25 subtracts 1 (one) from the sum of the scores. After the state becomes the state “confirmation,” the determiner 25 subtracts 2 (two) from the sum of the scores. Further, in a case where the determiner 25 determines that the candidate region 100 is the attached object region in the state “confirmation,” the determiner 25 does not add any to the sum of the scores, and maintains the sum. In other words, the determiner 25 adds 0 (zero) to the sum of the scores.

Before the state becomes the state “confirmation,” a figure to be subtracted from the sum of the scores is small so that the state does not easily fall back to the state “IDLE” and easily exceeds the threshold for the state “latency.” Then, there is a high possibility that the user removes the attached object after the state becomes the state “confirmation,” Thus, the figure to be subtracted is bigger so as to easily fall below the threshold for the state “latency.”

Therefore, it is possible to detect the attached object region immediately. In addition, in a case where the attached object is removed, it is possible to immediately determine the candidate region 100 is not the attached object region.

Since the determiner 25 determines that the candidate region 100 is the confirmed attached object region in the case where the determiner 25 continuously determines that the candidate region 100 is the attached object region, it is possible to invalidate a temporary erroneous determination caused by noise and the like of the captured image I.

Further, the determination process for the confirmed attached object region can be easily and accurately performed by giving a score to the determination of the confirmed attached object region.

As shown in FIG. 10, an FB threshold is set between a threshold for the state “IDLE” and a threshold for the state “latency.” In a case where the sum of the score of the candidate region 100 is equal to or greater than the FB threshold, the determiner 25 notifies the extractor 22 of a position of the candidate region 100 in the captured image I. Then, when a subsequent frame of the captured image I is input, the extractor 22 performs an extraction process for extracting the candidate region 100 based on the position of the candidate region 100 notified from the determiner 25.

In other words, since the determiner 25 gives to the extractor 22 a feedback about the position of the candidate region 100 equal to or greater than the FB threshold, the candidate region 100 in the same position in the captured image I is easily extracted by the extractor 22. Thus, it is possible to reduce delay in determining the attached object region caused by an erroneous extraction by the extractor 22. In other words, the attached object region can be detected immediately.

Then, the determiner 25 performs the determination process for continuity of the candidate region 100, and calculates an occupation percentage of the confirmed attached object region to perform a final determination process of the attached object. More specifically, in a case where a percentage of an area of the confirmed attached object region to a predetermined target region set in the captured image I is equal to or greater than a predetermined threshold (e.g., 40%), the determiner 25 determines that the attached object is on the lens of the camera 10. The target region may be an entire area or a portion of the captured image I.

Then, in a case where the determiner 25 determines that the attached object is on the lens, the determiner 25 outputs, to the devices 50, a signal indicating that the attached object flag is ON. In a case where the determiner 25 determines that the occupation percentage of the confirmed attached object region is smaller than the threshold, the determiner 25 determines that no attached object is on the lens, and outputs a signal indicating that the attached object flag is OFF.

In other words, information about ON or OFF of the attached object flag is information indicative of validity showing that the captured image I in a current frame is available for the devices 50, or information indicative of credibility of control performed by the devices 50 by use of the captured image I. Therefore, the determiner 25 may outputs to the devices 50 information indicative of the validity or the credibility of the captured image I, instead of the information about the attached object flag.

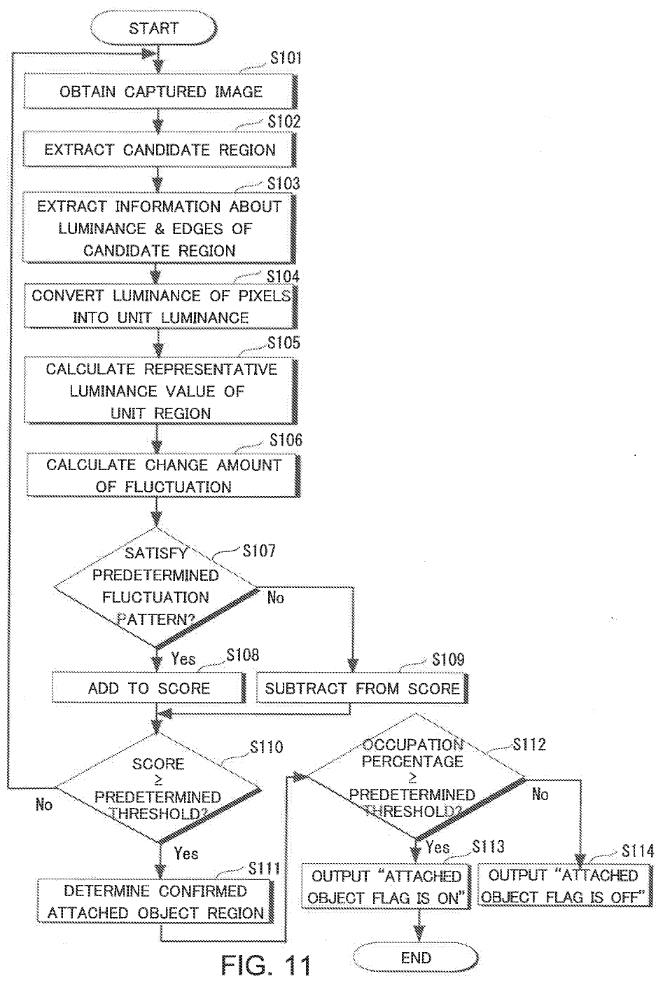

Next, with reference to FIG. 11, the process that is performed by the attached object detection apparatus 1 of this embodiment will be described. FIG. 11 is a flowchart that shows a procedure of the attached object detection process that is performed by the attached object detection apparatus 1 of this embodiment.

As shown in FIG. 11, the image obtaining part 21 first obtains an image captured by the camera 10, and performs the grayscale processing and the thinning process of the obtained image. After those processing, the image obtaining part 21 obtains, as the captured image I, an integral image generated based on values of pixels in the reduced image (a step S101).

Next, the extractor 22 extracts, based on the edges detected from the pixels in the captured image I obtained by the image obtaining part 21, the candidate region 100 for the attached object region corresponding to the attached object on the camera 10 (a step S102).

Moreover, the extractor 22 extracts the information about the luminance and the edges of the candidate region 100 (a step S103). Next, the converter 24 convers the luminance of the pixels in the candidate region 100 into the unit luminance that is generated by dividing the parameter of luminance by the predetermined range (a step S104).

Next, the calculator 23 divides the candidate region 100 into the predetermined number of the unit regions R, and calculates the representative luminance value of each of the unit regions R (a step S105). Next, the determiner 25 calculates the change amount of the fluctuation of the representative value of each unit region R in the candidate region 100 (a step S106).

Next, the determiner 25 determines whether or not the change amount of the fluctuation satisfies the predetermined fluctuation pattern (a step S107). In the case where the change amount satisfies the predetermined fluctuation pattern (Yes in the step S107), the determiner 25 adds a predetermined figure to the score of the candidate region 100 (a step S108). In the case where the change amount does not satisfy the predetermined fluctuation pattern (No in the step S107), the determiner 25 subtracts a predetermined figure from the score of the candidate region 100 (a step S109).

Next, the determiner 25 determines whether or not the score after the addition or the subtraction is equal to or greater than the predetermined threshold (a step S110). In the case where the score is smaller than the predetermined threshold (No in the step S110), the determiner 25 performs the process of the step S101. On the other hand, in the case where the score after the addition or the subtraction is equal to or greater than the predetermined threshold (Yes in the step S110), the determiner 25 determines that the candidate region 100 is the confirmed attached object region (a step S111).

Next, the determiner 25 determines that the occupation percentage that is a ratio of the confirmed attached object region to the target region of the captured image I is equal to or greater than the predetermined threshold (a step S112). In a case where the occupation percentage is equal to or greater than the predetermined threshold (Yes in the step S112), the determiner 25 outputs the signal indicating that the attached object flag is ON (a step S113), and ends the process.

On the other hand, in a case where the occupation percentage is smaller than the predetermined threshold (No in the step S112), the determiner 25 outputs the signal indicating that the attached object flag is OFF (a step S114), and ends the process.

As described above, the attached object detection apparatus 1 of this embodiment includes the extractor 22 and the determiner 25. The extractor 22 extracts, based on the edges detected from the pixels in the captured image I captured by the camera 10, the candidate region 100 for the attached object region corresponding to the attached object on the camera. The determiner 25 determines, based on the fluctuation of the luminance distribution of the pixels in the candidate region 100 extracted by the extractor 22, whether or not the candidate region 100 is the attached object region. Thus, the attached object can be accurately detected.

The foregoing embodiment uses the captured image I captured by the camera on the vehicle. The captured image I may be a captured image I captured by, for example, a security camera, camera installed on a street light, etc. In other words, the captured image may be any captured image captured by a camera of which a lens may have an attached object.

Further effects and modifications may be easily derived by a person skilled in the art. Therefore, a broader mode of the invention is not limited to the foregoing specific description and typical embodiments. Thus, various changes are possible without departing from the spirit or scope of the general concept of the invention defined by the attached claims and equivalents thereof.

While the invention has been shown and described in detail, the foregoing description is in all aspects illustrative and not restrictive. It is therefore understood that numerous other modifications and variations can be devised without departing from the scope of the invention.

What is claimed is:

1. An attached object detection apparatus, comprising:
an extractor that extracts, based on edges detected from pixels of a captured image captured by an image capturing apparatus, a candidate region for an attached object region corresponding to an attached object on the image capturing apparatus; and
a determiner that determines, based on a fluctuation of luminance distribution of pixels within the candidate region extracted by the extractor, whether or not the candidate region is the attached object region.

2. The attached object detection apparatus according to claim 1, wherein
the determiner determines, based on the fluctuation of the luminance distribution of the candidate region in a vertical direction or a horizontal direction, whether or not the candidate region is the attached object region.

3. The attached object detection apparatus according to claim 1, further comprising:
a calculator that i) divides the candidate region into unit regions each having predetermined pixels, and ii) calculates a representative luminance value for each unit region, wherein
the determiner determines, based on fluctuation of the representative luminance values of the candidate region, whether or not the candidate region is the attached object region.

4. The attached object detection apparatus according to claim 1, further comprising:
a converter that converts luminance of the pixels within the candidate region into unit luminance by dividing values of the luminance by a predetermined range, wherein
the determiner determines, based on fluctuation of distribution of the unit luminance, whether or not the candidate region is the attached object region.

5. The attached object detection apparatus according to claim 1, wherein
in a case where a fluctuation pattern of the luminance distribution of the candidate region satisfies a predetermined fluctuation pattern, the determiner determines that the candidate region is the attached object region.

6. The attached object detection apparatus according to claim 1, wherein
in a case where the fluctuation of the luminance distribution of the candidate region is convex shaped or concave shaped, the determiner determines that the candidate region is the attached object region.

7. The attached object detection apparatus according to claim 1, wherein
in a case where i) luminance of each pixel within a center region of the candidate region is equal to or greater than a first predetermined threshold, and also ii) an edge strength of each pixel within the center region of the candidate region is less than a second predetermined threshold, the determiner determines that the candidate region is the attached object region.

8. The attached object detection apparatus according to claim 1, wherein
in a case where the determiner continuously determines that the candidate region is the attached object region based on a plurality of the captured images captured time sequentially, the determiner determines that the candidate region is a confirmed attached object region.

9. The attached object detection apparatus according to claim 8, wherein
every time in which the determiner performs a determination process for determining whether or not the candidate region is the attached object region, the determiner gives to the candidate region a score according to a determination result, and determines that the candidate region of which a sum of the scores satisfies a predetermined threshold condition is the confirmed attached object region.

10. An attached object detection method comprising the steps of:
extracting, based on edges detected from pixels of a captured image captured by an image capturing apparatus, a candidate region for an attached object region corresponding to an attached object on the image capturing apparatus; and
determining, based on a fluctuation of luminance distribution of pixels within the candidate region extracted by the extractor, whether or not the candidate region is the attached object region.

11. A non-transitory computer-readable medium storing instructions that, when executed by a processor of a controller, cause the processor to:
extract, based on edges detected from pixels of a captured image captured by an image capturing apparatus, a candidate region for an attached object region corresponding to an attached object on the image capturing apparatus; and
determine, based on a fluctuation of luminance distribution of pixels within the extracted candidate region, whether or not the candidate region is the attached object region.
